(19) United States
(12) Patent Application Publication
(10) Pub. No.: US 2013/0038702 A1
(43) Pub. Date: Feb. 14, 2013

(54) SYSTEM, METHOD, AND COMPUTER PROGRAM PRODUCT FOR PERFORMING ACTIONS BASED ON RECEIVED INPUT IN A THEATER ENVIRONMENT

(71) Applicants: Limor Schweitzer, Estoril (PT); Uri Kareev, Tel Aviv (IL)

(72) Inventors: Limor Schweitzer, Estoril (PT); Uri Kareev, Tel Aviv (IL)

(73) Assignee: IMAX CORPORATION, Mississauga, ON (CA)

(21) Appl. No.: 13/583,614

(22) PCT Filed: Mar. 9, 2011
(86) PCT No.: PCT/CA2011/000263

§ 371 Date: Oct. 24, 2012

Related U.S. Application Data
(60) Provisional application No. 61/312,169, filed on Mar. 9, 2010.

(51) Int. Cl. H04N 9/67; H04N 13/04

(52) U.S. Cl. 348/51; 348/659; 348/E09.047; 348/E13.075

(57) ABSTRACT

A system, method, and computer program product are provided for performing actions based on received input in a theater environment. In operation, content is displayed to a plurality of users in a theater environment. Additionally, input from one or more of the plurality of users is received in response to the displaying. Further, one or more actions are performed based on the received input.

### CLAIM OF PRIORITY

This application claims the benefit of U.S. Provisional Patent Application 61/312,169, entitled “System, method, and computer program product for providing an interactive multi-user theater experience,” by Schweitzer et al., filed Mar. 9, 2010 (Attorney Docket No. IMAXP001+), the entire contents of which are incorporated herein by reference.

### FIELD OF THE INVENTION

The present invention relates to interacting with a plurality of users, and more particularly to displaying content to and receiving input from the users.

### BACKGROUND

One popular method for a plurality of users to view displayed content is by attending a theater environment. For example, a plurality of users may view a movie or other displayed event at a movie theater. However, current methods of interacting with users in such an environment have generally exhibited various limitations.

For example, the displayed content shown by theater environments to users may be static, and may not be able to be personalized to a particular user as a result. Additionally, users may not be able to interact with the displayed contact. There is thus a need for addressing these and/or other issues associated with the prior art.

### SUMMARY

A system, method, and computer program product are provided for performing actions based on received input in a theater environment. In operation, content is displayed to a plurality of users in a theater environment. Additionally, input from one or more of the plurality of users is received in response to the displaying. Further, one or more actions are performed based on the received input.

### BRIEF DESCRIPTION OF THE DRAWINGS

FIG. 1 shows a method for performing actions based on received input in a theater environment, in accordance with one embodiment.

FIG. 2 shows a method for displaying a plurality of sets of content to a user, in accordance with one embodiment.

FIG. 3 shows an example of a partially synchronized overlay, in accordance with another embodiment.

FIG. 4 shows an exemplary see-through display system, in accordance with one embodiment.

FIG. 5 shows an exemplary overlay image structure, in accordance with another embodiment.

FIG. 6 illustrates an exemplary hardware system for in-theater interactive entertainment, in accordance with yet another embodiment.

FIG. 7 illustrates an exemplary system in which the various architecture and/or functionality of the various previous embodiments may be implemented.

### DETAILED DESCRIPTION

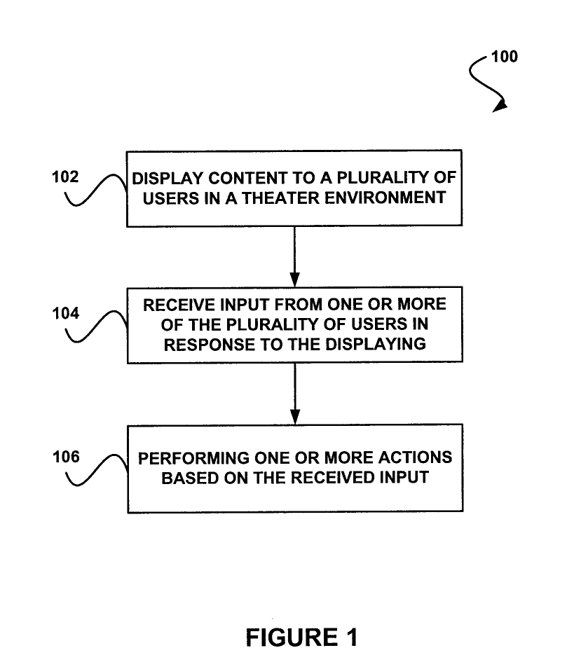

FIG. 1 shows a method 100 for performing actions based on received input in a theater environment, in accordance with one embodiment. As shown, content is displayed to a plurality of users in a theater environment. See operation 102. In one embodiment, the content may include one or more images, one or more video segments, etc. In another embodiment, the content may be accompanied by an audio element. For example, the content may include a movie, a television show, a video game, etc.

Additionally, in one embodiment, the theater environment may include any environment in which the plurality of users may gather to concurrently view the content. For example, the theater environment may include a movie theater, a stadium, etc. In another embodiment, the plurality of users may include customers of the theater. For example, the plurality of users may have purchased tickets to view the content in the theater environment.

In yet another embodiment, the content may be concurrently displayed to the plurality of users utilizing a plurality of displays. For example, a first portion of the content may be displayed to the plurality of users utilizing a first display, and a second portion of the content may be displayed to the plurality of users utilizing a plurality of additional displays separate from the first display. In another example, the first display may include a main theater screen, and the additional displays may include one or more of head displays, portable displays (e.g., portable screens, etc.), etc.

Further, as shown in operation 104, input from one or more of the plurality of users is received in response to the displaying. In one embodiment, the input may be sent utilizing a plurality of devices each controlled by one of the plurality of users. For example, the input may be sent utilizing a hand-held device provided by the theater, such as a controller, gamepad, etc. In another embodiment, the input may be sent utilizing a device supplied by each of the plurality of users, such as the user's cellular telephone, laptop computer, personal digital assistant (PDA), etc. In yet another embodiment, the input may include one or more of voice input, inertial movement input (i.e., gesture-based input, etc.), input based on the movement of a user's head, etc.

Further still, in one embodiment, the input may include a request to perform one or more actions associated with the displayed content. For example, the displayed content may include a movie, and the input may include a rating of the movie, a request to view additional information associated with a currently displayed portion of the movie, a request to view another portion of the movie, a response to a question associated with the movie, etc. In another example, the displayed content may include a video game, and the input may include a request to perform one or more actions within the video game, a request to view one or more user statistics within the video game, a request to change the user viewpoint within the video game, etc.

Additionally, in one another example, the input may include a request to control one or more elements of a display within the theatre environment. For example, one or more users may participate in one or more interactive events (e.g., games, etc.) within the theatre environment, and may control a device through an interface through which they may control one or more elements of a display within the theatre environment. In one embodiment, the device and/or the interface may be brought with the user in advance. In another embodiment, the device and/or the interface may be provided to the user at the theatre environment.

Also, as shown in operation 106, one or more actions are performed based on the received input. In one embodiment, the one or more actions may include altering the displayed content according to the received input. For example, a viewpoint of one or more users with respect to the displayed content may be changed. In another example, the one or more actions may include overlaying additional content onto the displayed content. In another embodiment, the one or more actions may include displaying additional content to one or more users. For example, the results of a poll or quiz, game statistics, movie trivia, the current time, or any other content may be displayed to one or more users. In another example, supplemental game event data (e.g., data such as health, ammunition, coordination, etc.) may be viewed by one or more users overlaid on the main display.

In yet another example, a single user may participate in an event, where the user may view only his own data overlaid on a main display (e.g., by a head display, etc.). In yet another example, a group of users may participate in the event, where a user may view additional data related to other users in addition to his own data overlaid on a main display. For instance, the additional data may be generated according to the actions of some or all of the other users. In still another example, data personally associated with one or more users may be displayed to the plurality of users.

In yet another embodiment, the one or more actions may include performing one or more actions within the displayed content. For example, a character or other icon associated with a user within the displayed content may be moved or may perform one or more actions within the displayed content based on one or more movement or action commands sent by the user.

Additionally, in one embodiment, the displayed content may be included within an event, and the actions performed by a user or a group of users may affect the outcome of one or more portions of the event. In another embodiment, actions performed by a user or a group of users may not affect the outcome of the event (e.g., data may be overlaid and may elaborate on a portion of a movie scene, game, etc.). In yet another embodiment, data may be overlaid on a main display of the theatre environment and may affect the outcome of one or more portions of the event. In still another embodiment, the data overlaid on the main display may not affect the outcome of the event (e.g., the data overlaid may elaborate on a portion of a movie scene, game, etc.).

Further, in one embodiment, one or more additional methods of interacting with an event associated with the display content may be provided. For example, one or more game play options may be provided by monitoring user movement during the game, where one or more predetermined movements of a user correspond to one or more actions performed in the game. In another embodiment, one or more viewpoints of the displayed content may be viewable by a user during the event. For example, during a game, a viewpoint of a user may be changed (e.g., via the head display, portable display, etc.) from a first-person shooter view, to a flight action view, to a shooting from a helicopter view, etc.

Further still, in one embodiment, the received input may include participation from one or more of the plurality of users in a large scale event (e.g., video game battle, etc.), where such event takes place on a main screen of the theatre environment, and where one or more elements of the event may be customized to a particular user's viewpoint. For example, a user's avatar and/or group may be highlighted via a head display and/or portable display of a user, an individual zoom screen may be provided via the head display and/or portable display of a user, etc.

Also, in one embodiment, a scenario in which the interactive experience takes place may be static. For example, the displayed content may include a static background and on it one or more enemies appear or move (e.g., firing from a bunker or a foxhole, etc.). In another embodiment, a scenario in which the interactive experience takes place may be semi static. For example, the displayed content may include a static background but with movement between different backgrounds, replacements of the background, etc. In yet another embodiment, a scenario in which the interactive experience takes place may be dynamic. For example, the displayed content may be moving around (e.g. from the viewpoint of a helicopter, a turret of a driving tank, etc.).

Additionally, in one embodiment, one or more icons (e.g., an avatar, etc.) may be associated with each of the plurality of users. In another embodiment, the icons may be static (e.g., located in the same place on a main screen of the theater environment, etc.). In yet another embodiment, the icons may be semi static (e.g., the icon location may change in a manner irrespective of the player's action, etc.). In still another embodiment, the icons may be dynamic (e.g., the icon location may change based on the players actions, etc.).

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

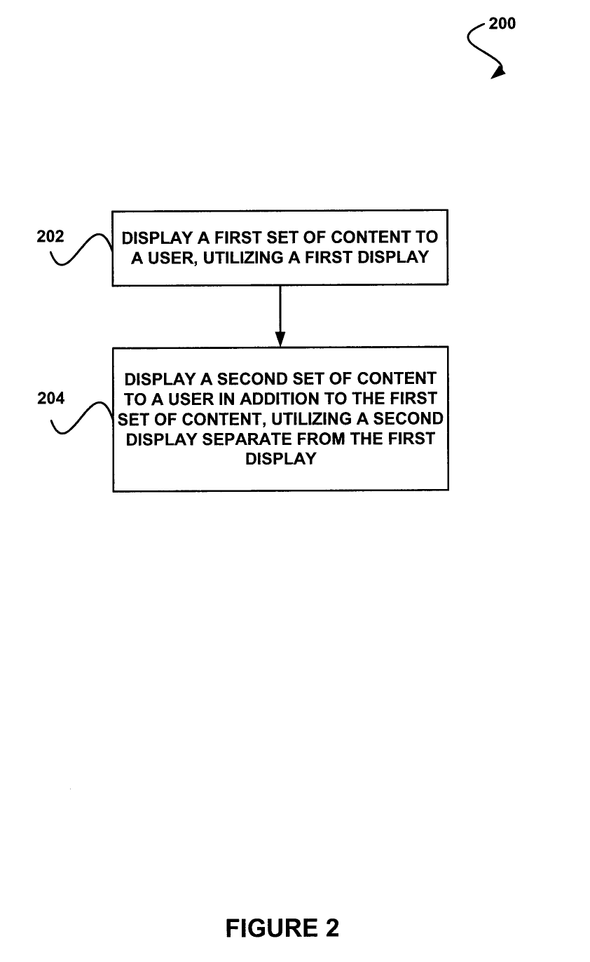

FIG. 2 shows a method 200 for displaying a plurality of sets of content to a user, in accordance with one embodiment. As an option, the present method 200 may be implemented in the context of the functionality and architecture of FIG. 1. Of course, however, the present method 200 may be implemented in any desired environment. It should also be noted that the aforementioned definitions may apply during the present description.

As shown in operation 202, a first set of content is displayed to a user, utilizing a first display. In one embodiment, the first display may include a screen. For example, the first display may include a background display, a projection screen, a television, a large main screen, or any other device that allows for content to be displayed. In another embodiment, the first display may be located in a theater environment. For example, the first set of content may be viewed by a plurality of users within the theater environment.

Additionally, as shown in operation 204, a second set of content is displayed to the user in addition to the first set of content, utilizing a second display separate from the first display. In one embodiment, the second set of content may be associated with the first set of content. For example, the second set of content may include content that supplements the first set of content. For instance, the first set of content may include a movie, and the second set of content may include one or more details associated with the movie (e.g., trivia regarding the movie, the movie director's comments, etc.).

In another embodiment, the second set of content may include information associated with the user. For example, the first set of content may include a video game, and the second set of content may include game statistics associated with the user (e.g., the user's score in the game, health status within the game, etc.). In yet another embodiment, the second display may include a display worn by the user. For example, the second display may include a head-up display (HUD) such as a see-through display worn on the user's head.

Further, in one embodiment, the second display may include a screen. For example, the second display may include a portable display. For example, the user may view a portable display in addition to the first display. In another example, the user may shift their eyes from the main display to the portable display in order to see important information and be involved in certain phases of an event (e.g., a game, movie, quiz, etc.) displayed on one or more of the first and second display.

Further still, in one embodiment, the second set of content may be combined with the first set of content, utilizing the first and second displays. For example, a see-through display may be used by one or more users to see personalized visuals overplayed on top of a displayed main screen projection within the theater environment.

In another embodiment, one or more of the first and second sets of content may adjust according to the user's movement. For example, a user may wear a head display and may move their head and eyes, and the head display may have a particular field of view (FOV) where the second set of content may be seen as an overlay display. In yet another embodiment, an unsynchronized overlay may be provided. For example, one or more visual images displayed on the head display may move as the player moves his head. In this way, the display of textual and numerical information on the edges of the FOV may be enabled.

Also, in one embodiment, a synchronized overlay may be provided. For example, visual images displayed on the head display may be shown in the head display in such a way that they appear to the user to be situated on an additional display other than the head display (e.g., on a background theatre screen, etc.). In another example, the visual images displayed on the head display may appear to be stationary on the additional display. In yet another example, a synchronized overlay may be provided for one or more areas of the additional display (e.g., an area around the centre of a theatre screen, etc.).

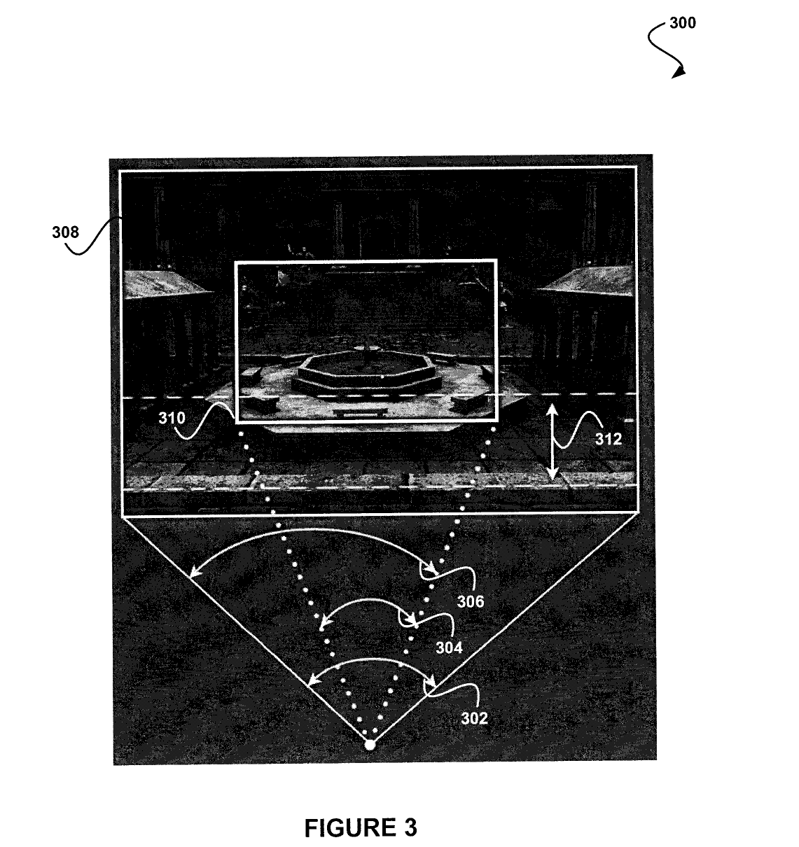

Additionally, in one embodiment, a partially synchronized overlay may be provided. For example, visual images may be rendered in the head display in a way that they seem to be constrained in one dimension on the additional display other than the head display. In another example, the visual images rendered in the head display may be constrained to a horizontal band, a vertical band, etc. In yet another example, when a user moves his head, one or more visual images rendered in the head display may move as well, but the visual images may only move on the X axis and seem constrained and immobile on the Y axis with respect to the additional display, the visual images may only move on the Y axis and seem constrained and immobile on the X axis with respect to the additional display, etc. One example of this partially synchronized overlay is shown in FIG. 3, which illustrates a field of view movement 302, a maximum synchronization field of view 304, a field of view of the head displaying 306, a move visible area 308, a sync area 310, and a partial sync area constrained in the Y-axis 312.

Further, in one embodiment, if the second display includes a head display, the second set of content may be transformed both in terms of geometry and stereo content of the overlay visuals in order to provide a coherent image to the user, given that the user may shift his head together with the second display. In another embodiment, to enable synchronized visual images, the second display may receive information relating to a location of the first display. In this way, the second display visuals may be translated and skewed to reflect a position of a user's head with respect to the first display, which may create an affine transformation of the head display. For instance, a shape of a screen may not be a right-angled rectangle but may be skewed based on where the player sits in the cinema, etc.

Further still, in another embodiment, if the second display includes a head display, calibration of the second display with respect to the first display may be done using a head tracker that utilizes infrared reference points on the edges of the first display. In yet another embodiment, there may be no need for gyros and other sophisticated inertial moment units and associated error correction systems because the tracking may only need to know the location of the first display and its four corners and this information may be conveyed by the first display to sensors on the second display.

Also, in one embodiment, if the second display includes a head display, and if the head display has a single source visual and does not provide stereo-vision, then the displayed overlay screen may be located at a position designated as infinity. Therefore any stereo-vision object in three-dimensional (3-D) space on the first display visuals may be located logically in-front of the overlay display and therefore the overlay display visuals may include appropriate “holes” to accommodate for the virtual 3-D space objects. In this way, a situation where a 3-D object from the first display that may be obscured by the overlay screen which is supposed to be visually located at infinity may be avoided, thereby precluding any 3-D space distortion to the user.

Additionally, in one embodiment, the second display may include a head display composed of independent stereo views, such that the 3-D visuals may contain objects that are not in infinity (like the non-stereo vision head display), but are virtually located in 3-D space. Additionally, the two displays may therefore have consistent 3-D objects such that the illusion of coherent stereo vision 3-D is not disrupted. In this way, these objects may co-exist with the 3-D objects created by the first display.

Further, in one embodiment, if the second display includes a heads up display, the heads up display may be used to show game data, spatially synchronized with the first set of content (e.g., a player avatar may be shown on the heads up display moving on a scene projected on the main screen, etc.). In another embodiment, in order to maintain the spatial synchronization between the data projected in the heads up display with the first set of content, a tracking mechanism may be used. In yet another embodiment, such a tracking mechanism may find position or orientation data of the heads up display so it may adjust the overlaid image accordingly, so it may appear to the player in the right place within the first set of content.

Further still, in one embodiment, such tracking mechanism may determine the position and orientation of the first display relative to the second display. This may use one or more cameras attached to the second display. In another embodiment, pre-known video sources may be placed in pre-known places in the theatre environment, so enough data may be available with respect to the second display so that its image may be spatially synchronized with the first display. For example, infrared sources may be located at pre known positions around a screen, for instance at the corners of the screen. The camera and their processing may seek the sources, determine the four corners of the screen and calculate an affine transformation that may be applied to the head display and/or portable display so that an image displayed within the head display and/or portable display may correspond to a shape of the screen relative to the seating position of the user in the theatre environment.

Also, in one embodiment, the user may be included within a group of one or more players participating in an event in an action/arcade format that takes place in a world displayed on a main screen of a theater environment. In another embodiment, enemies may appear and the players may fight them either individually or as a group. In yet another embodiment, in the action/arcade format a player may have some of the data related to his action appear on his personal display device. For example, this information may include one or more of: health/life status, inventory, avatar display, special effects relating to the players actions, the player's sight/crosshair, the players shots, enemy fire that may affect the player, enemies, etc.

In still another embodiment, in the action/arcade format, some of the game data may appear on the main screen. This data may include some of the following: enemies, enemy fire, enemy related effects, enemy data such as enemy health status, players' avatars, players' shots, player related effects, etc. Of course, however, any data associated with one or more computer-generated and/or live participants in the game may appear on the main screen. In another embodiment, the player may control in the action/arcade scenario some of the following: attacks (e.g., shots, blows, special attacks, etc.), movement, defence (e.g. raising a shield or blocking an attack, etc.), enemy attack avoidance, selection of weapons/item usage, collection of goods (e.g. weapons, ammunition, health bonuses, etc.), etc.

Additionally, in one embodiment, the action/arcade format may include a scenario such as being located at a bunker or a foxhole, or any other form of stationary location (e.g., fighting with oncoming enemies, etc.). In another embodiment, the action/arcade format may include a scenario such as being located in a moving vehicle, perhaps with limited movement capabilities in the vehicle, and fighting from the vehicle, where vehicles may include, besides traditional vehicles, trains, carts, futuristic vehicles and flying vehicles, etc. In yet another embodiment, the action/arcade format may include scenarios such as controlling a movement of a vehicle, flying or controlling a flying vehicle, conducting ranged weapons warfare, conducting melee based warfare, conducting martial arts based battle, etc.

Further, in one embodiment, the user may be included within a group of one or more players participating in an event in an epic battle format that takes place in a world displayed on a main screen of a theater environment. For example, in the epic battle format all players may have identical roles, or different players may have different roles. In another example, in the epic battle format the large screen may display the epic battle scenario. Additionally, in the epic battle scenario the individual player data rendered may include some of the following: highlighting of the players avatar on the large screen, personal data such as health/life, abilities, zoom of the player's avatar vicinity, highlighting of current objectives, etc.

Further still, in one embodiment, the user may be included within a group of one or more players participating in an event in a role playing format where each player may move throughout a world environment, interacting with other characters, and fulfilling various tasks. For example, in the role playing embodiment the first display may display the scenario and one or more of the following: computer controlled characters, items for interaction, battle related data as described in the action/arcade embodiment, etc. In another example, in the role playing embodiment the second display may display one or more of the following: the player avatar, the interaction with other characters, the results of the players action, players' progress through their tasks, battle data as described in the action/arcade embodiment, etc.

Also, in one embodiment, the user may be included within a group of one or more players participating in an event in an interactive movie format. For example, players may interact with the movie (e.g., by throwing virtual objects (such as tomatoes, etc.) onto the screen, etc.). In another embodiment, the storyline in an interactive movie may be affected by the actions of one or more of the viewers.

Additionally, in one embodiment, the user may be included within a group of one or more players participating in an event in a murder mystery format. For example, the user may participate in a game including video footage consisting of identifying someone in the crowd who has allegedly committed a crime. The game may provide clues and the players may have to use their personal devices to find challenge objectives and help solve the crime.

Further, in one embodiment, the user may be included within a group of one or more players participating in an event in a puzzle format. For example, the puzzle format may consist of individual and group objectives where the input devices may be used to search through virtual worlds and search for answers. In another embodiment, the user may be included within a group of one or more players participating in an event in a crowd decides format. For example, a movie may be shown to the user whose plot is decided by votes of the crowd.

Further still, in one embodiment, the user's identity may be combined with an event they participate in (e.g., a gaming experience, movie viewing experience, etc.). For example, based on an identification (ID) card (e.g., a loyalty card, an identification card, etc.), the user may be identified before or during the event. Additionally, a personalized reception may be offered to the user based on the identification of the user. Further, personal treatment may be provided to the user based on one or more elements associated with the identity of the user (e.g., the quality of the user's game play, etc.). At the end of the gaming event, feedback based on the user's performance and identity may be given, such as notification of the best performing players, the most improving players, displaying scores and levels of users, etc.

Also, in one embodiment, the ID of the user may be anonymous and may be composed of a miniature device (including features such as radio frequency identification (RFID), etc.) that may provide location and identification information associated with the user. In another embodiment, the same device may be plugged into a player input device or head display in order for the interactive experience to recognize the user and credit his points in the central user database. For example, a central database of users may store all gaming related information whenever a player goes to a theatre that uses the IDs. This information may include sessions played, scores, achievements earned, ranks or levels, etc.

In yet another embodiment, the personal information may also be accessed from a user's home and additional social interaction areas (e.g., user groups, forums, etc.) where a user may be addressed based on a chosen identity, or a user boasting of their gaming achievements may benefit from user identification. In another embodiment, location information of the user may be used to interact with the user in any manner. For example, a location of the user within a particular location (e.g., a pre-theatre hall, etc.) may be used to display one or more images on one or more screens within the particular location, play one or more sounds within the particular location, or otherwise react to a user's presence.

In addition, in one embodiment, a software development kit (SDK) may allow third party developers to develop content for a particular platform that displays the first and second sets of content, and may provide an easy to use interface to its various subsystems (e.g., overlay/handheld visual information, input devices, etc.). For example, the SDK may allow an interface to hundreds of simultaneous users, and all their peripherals, I/O devices, commands, inter-player aspects, etc.

In another embodiment, the aforementioned technology may be incorporated into a development platform. For example, a game engine or an SDK for a game display application may include an option to render or display separately the background and a foreground of the game, where a portion of the game is to be shown on a main screen, and another portion of the game is to be shown on a head display, portable display, etc. Such development platform may also provide the developer with an easy interface to other system elements (e.g., the input device, connection between players, the players identification, etc.).

Further, in one embodiment, stereo vision and/or 3-D image rendering may be added to the game engine. This 3-D support, together with other systems changes, may allow the game engine to render in 3-D where such rendering is needed, be it in the main screen image, or if needed in the player specific rendering. In another embodiment, one or more portions of event data may be streamed, while another portion of event data may be constant.

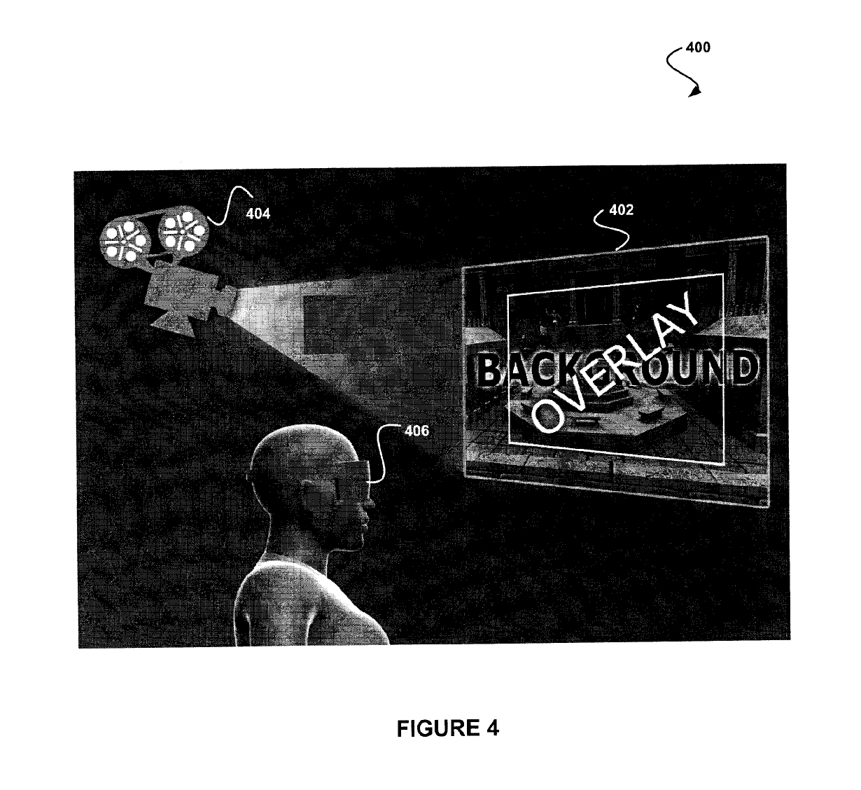

FIG. 4 shows an exemplary see-through display system 400, in accordance with one embodiment. As an option, the present system 400 may be implemented in the context of the functionality and architecture of FIGS. 1-3. Of course, however, the present system 400 may be implemented in any desired environment. It should also be noted that the aforementioned definitions may apply during the present description.

As shown, the see-through display system 400 includes a background screen 402. In one embodiment, background visuals (e.g., a background scene of a video game, etc.) may be displayed on the background screen 402. In another embodiment, a movie may be displayed on the background screen 402. Additionally, the see-through display system 400 includes a cinema projector 404. In one embodiment, the cinema projector 404 may project content (e.g., background visuals, movies, etc.) onto the background screen 402.

Further, the see-through display system 400 includes a head display 406. In one embodiment, the head display 406 may be worn by a user and may include a miniature projector and transparent display overlay. In this way, the user wearing the head display 406 may view both the content displayed on the background screen 402 as well as overlaid content provided by the head display 406.

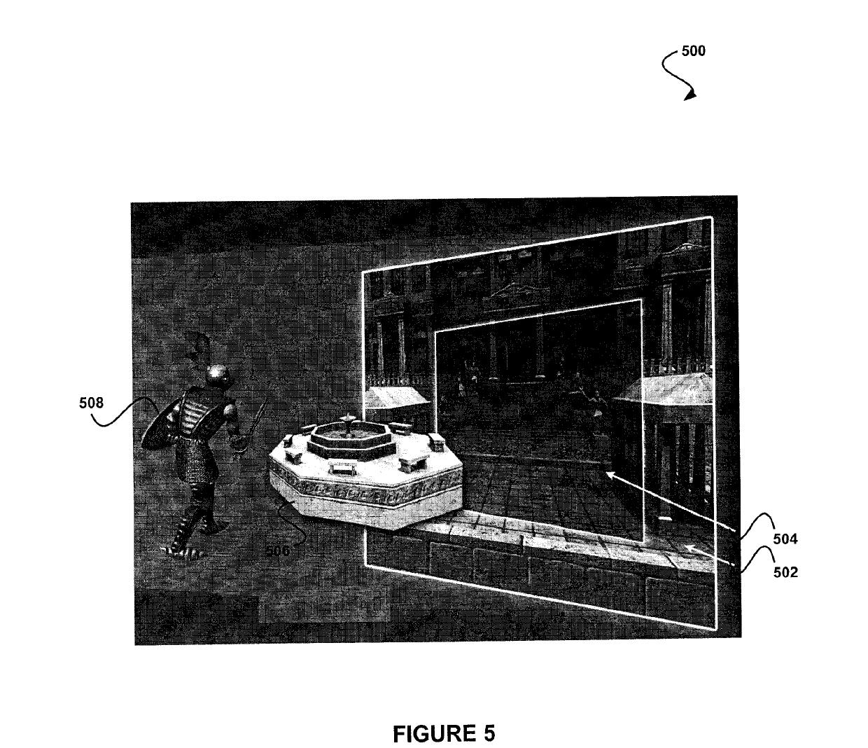

FIG. 5 shows an exemplary overlay image structure 500, in accordance with one embodiment. As an option, the overlay image structure 500 may be implemented in the context of the functionality and architecture of FIGS. 1-4. Of course, however, the present overlay image structure 500 may be implemented in any desired environment. It should also be noted that the aforementioned definitions may apply during the present description.

As shown, the overlay image structure 500 includes background content 502, as well as overlay image 504. In one embodiment, both background content 502 and overlay image 504 may be in mono vision, and the overlay image 504 may floss with the background content 502. Additionally, the overlay image structure 500 includes a 3-D virtual object background 506 as well as a 3-D virtual object overlay 508. In one embodiment, the 3-D virtual object background 506 may be displayed to a user utilizing a background display, and the 3-D virtual object overlay 508 may be displayed to the user utilizing a head display. In this way, different three-dimensional objects may be displayed to a user utilizing a plurality of different displays.

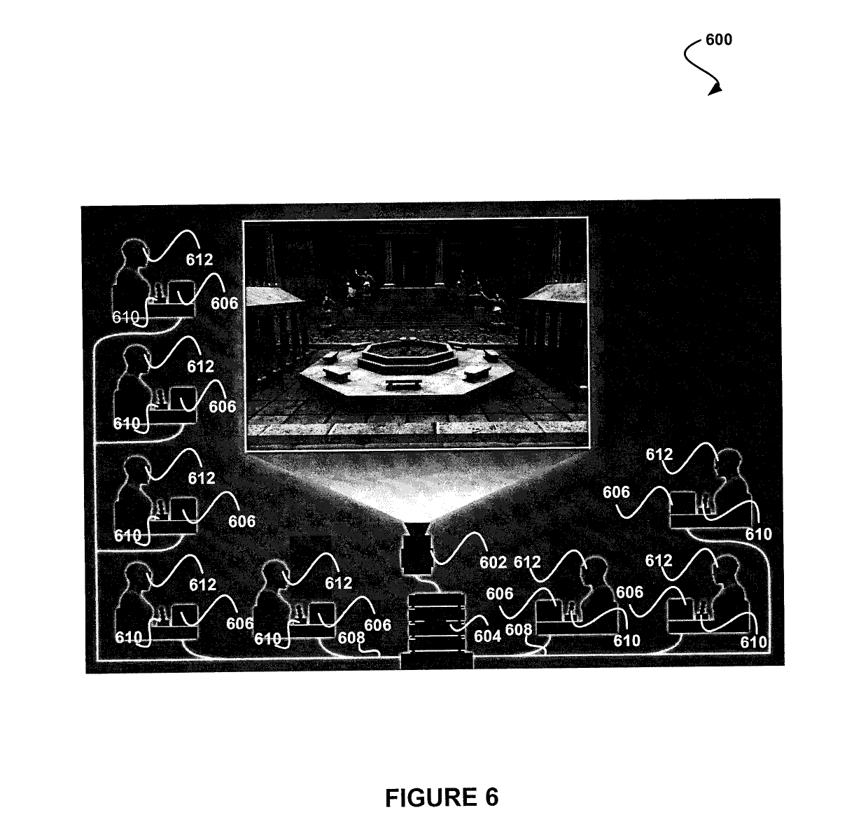

FIG. 6 shows an exemplary hardware system 600 for in-theater interactive entertainment, in accordance with one embodiment. As an option, the system 600 may be implemented in the context of the functionality and architecture of FIGS. 1-5. Of course, however, the present system 600 may be implemented in any desired environment. It should also be noted that the aforementioned definitions may apply during the present description.

As shown, the hardware system 600 includes a background projector 602 in communication with a centralized computing system 604. In one embodiment, the background projector 602 may provide a background image within a theater environment. In another embodiment, the background projector 602 may include one or more projectors, and the centralized computing system 604 may include a central processing platform. Additionally, the centralized computing system 604 is in communication with a plurality of personal computing systems 606 via a data distribution system 608. In one embodiment, the data distribution system 608 may include wired data distribution, wireless data distribution, or a combination of wired and wireless data distribution.

In another embodiment, one or more of the plurality of personal computing systems 606 may include game play processing and/or video decompression. Further, each of the personal computing systems 606 may include a player input device 610 and a player overlay display 612. In one embodiment, each player input device 610 may have a display on it. Further still, in one embodiment, a game may be played within the hardware system 600 and may be played on a central processing cloud, and compressed or uncompressed video data may be distributed to each of the personal computing systems 606. In another embodiment, each gamer may have a personal computing system 606 on which game software is run, and the centralized computing system 604 may deal with the background imagery, inter-player data, etc. In still another embodiment, each game may be played individually by a single player, with no cooperation between players.

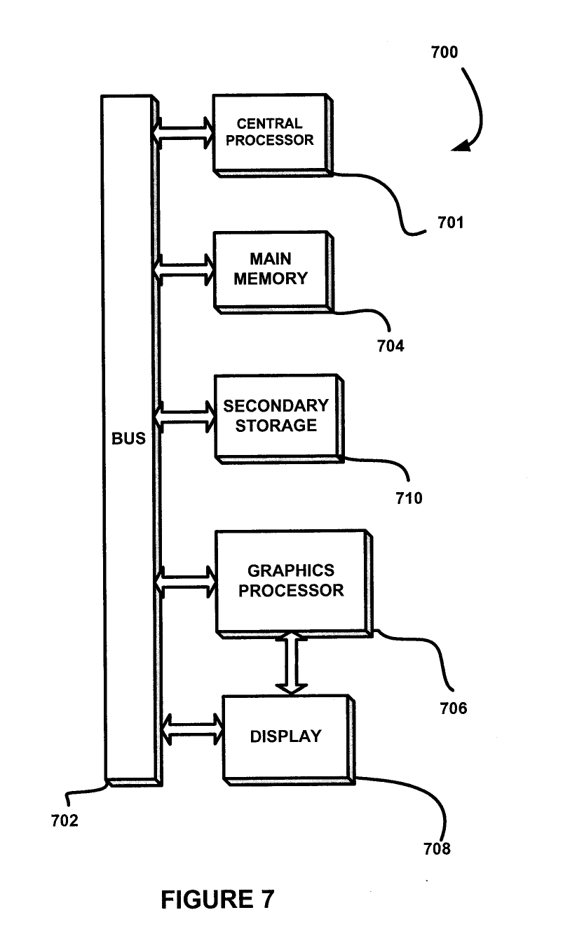

FIG. 7 illustrates an exemplary system 700 in which the various architecture and/or functionality of the various previous embodiments may be implemented. As shown, a system 700 is provided including at least one host processor 701 which is connected to a communication bus 702. The system 700 also includes a main memory 704. Control logic (software) and data are stored in the main memory 704 which may take the form of random access memory (RAM).

The system 700 also includes a graphics processor 706 and a display 708, i.e. a computer monitor. In one embodiment, the graphics processor 706 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710. The secondary storage 710 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 704 and/or the secondary storage 710. Such computer programs, when executed, enable the system 700 to perform various functions. Memory 704, storage 710 and/or any other storage are possible examples of computer-readable media.

In one embodiment, the architecture and/or functionality of the various previous figures may be implemented in the context of the host processor 701, graphics processor 706, an integrated circuit (not shown) that is capable of at least a portion of the capabilities of both the host processor 701 and the graphics processor 706, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, lap-top computer, and/or any other type of logic. Still yet, the system 700 may take the form of various other devices including, but not limited to, a personal digital assistant (PDA) device, a mobile phone device, a television, etc.

Further, while not shown, the system 700 may be coupled to a network [e.g. a telecommunications network, local area network (LAN), wireless network, wide area network (WAN) such as the Internet, peer-to-peer network, cable network, etc.] for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1.-20. (canceled)

21. A method, comprising:
displaying a first image to be viewed by a plurality of viewers;
displaying a second image to be viewed by a single viewer of the plurality of viewers; and
spatially synchronizing the second image with respect to the first image;
wherein the first image and the second image are overlaid;
wherein a position of the second image with respect to the first image is modified;
wherein the single viewer views the first image and the second image for an interactive experience.

22. The method of claim 21, wherein the position of the second image with respect to the first image is influenced by the single viewer.

23. The method of claim 21, wherein a content of the second image is influenced by the viewer.

24. The method of claim 21, wherein the second image is different for each of the plurality of viewers.

25. The method of claim 21, wherein the first image includes three-dimensional (3-D) image content.

26. The method of claim 21, wherein the second image includes three-dimensional (3-D) image content.

27. The method of claim 21, wherein the first and second images include three-dimensional (3-D) image content.

28. The method of claim 21, wherein the second image is constrained with respect to the first image to only move vertically or horizontally or to have a fixed field of view.

29. The method of claim 21, wherein the second image is a two-dimensional (2-D) image located at infinity and the first image is a three-dimensional (3-D) image which includes a stereo vision object in three-dimensional (3-D) space and the second image is modified with holes to accommodate the virtual three-dimensional (3-D) space object being in front of the two-dimensional (2-D) space.

30. The method of claim 21, wherein the second image and the first image are three-dimensional (3D) images and the second image is modified to accommodate objects in the second image to appear within the three-dimensional (3D) space of the first image.

31. The method of claim 21, wherein the first image is static and the second image is dynamic.

32. A cinema theater, comprising:
a first display for displaying a first image to be viewed by a plurality of viewers;
a second display for displaying a second image to a single viewer of the plurality of viewers, where the second image is overlaid upon the first image;
at least one tracking mechanism to spatially synchronize the second image with the first image; and
a computing device for controlling the second display;
wherein the computing device modifies the second image based on the at least one tracking mechanism;
wherein the viewer influences a position of the second image with respect to the position of the first image for an interactive experience.

33. The system of claim 32, wherein the second display is a transparent head mounted display.

34. The system of claim 32, wherein the tracking of the first display relative to the second display is performed by a head tracking sensor connected to the second display.

35. The system of claim 32, wherein the viewer can provide additional input to the computing device to modify the second image.

36. The system of claim 32, wherein the tracking mechanism is a camera.

37. The system of claim 32, further comprising a central computing device in communication with the computing device where the central computing device controls the first image.

38. The system of claim 37, wherein the central computing device communicates with multiple computing devices to create interaction among multiple viewers.
